(19) United States
(12) Patent Application Publication
(10) Pub. No.: US 2026/0148034 A1
(43) Pub. Date: May 28, 2026

(54) SYSTEMS AND METHODS FOR GENERATING A TEACHING AVATAR USING MACHINE LEARNING

(71) Applicants: Constructor Technology AG, Schaffhausen (CH); Constructor Education and Research Genossenschaft, Schaffhausen (CH)

(72) Inventors: Sergey ULASEN, Singapore (SG); Andrei BOIAROV, Sofia (BG); Andrey ADASCHIK, Istanbul (TR); Ilya BAIMETOV, Seattle, WA (US); Alexander TORMASOV, Busingen am Hochrhein (DE); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 18/959,807

(22) Filed: Nov. 26, 2024

(51) Int. Cl. G06N 3/006

(52) U.S. Cl. CPC G06N 3/006

(57) ABSTRACT

Disclosed herein are systems and method for generating a teaching avatar using machine learning. A method may include training, using a first machine learning algorithm, a teaching avatar to recite information using speech-based mannerisms and physical gestures of a real-life teacher, wherein the training is performed with a training dataset comprising videos and transcripts of real-life teachers administering courses. The method may include receiving a class attribute comprising information about at least one student of a course. The method may include setting a visual appearance and an audio configuration of the teaching avatar based on the class attribute. The method may including generating, using a second machine learning algorithm, a script based on the course. The method may include executing, on a computing device, the teaching avatar to recite the script with the speech-based mannerisms and physical gestures of the real-life teacher.

### FIELD OF TECHNOLOGY

The present disclosure relates to the field of machine learning, and, more specifically, to systems and methods for systems and methods for generating a teaching avatar using machine learning.

### BACKGROUND

Traditional graphical user interfaces (GUIs) have long served as the primary means of presenting educational content, attempting to bridge the gap between information and learners. However, the shortcomings of conventional GUIs in effectively displaying educational content such as courses have become increasingly evident. For example, such interfaces often struggle to cater to the diverse needs and preferences of users, leading to inefficiencies, frustrations, and missed opportunities for engagement. This failure stems from several key limitations inherent in traditional GUI design approaches, including static layouts, information overload, lack of personalization, and inadequate accessibility features.

### SUMMARY

To address the shortcomings of conventional graphical user interfaces (specifically those that display educational content such as course material), the present disclosure describes generating a teaching avatar using machine learning. The teaching avatar is configured to present educational material in a guided manner that aids user(s) in comprehension and course navigation.

In one exemplary aspect, the techniques described herein relate to a method for generating a teaching avatar using machine learning, the method including: training, using a first machine learning algorithm, a teaching avatar to recite information using speech-based mannerisms and physical gestures of a real-life teacher, wherein the training is performed with a training dataset including videos and transcripts of real-life teachers administering courses; receiving a class attribute including information about at least one student of a course; setting a visual appearance and an audio configuration of the teaching avatar based on the class attribute; generating, using a second machine learning algorithm, a script based on the course; and executing, on a computing device, the teaching avatar to recite the script with the speech-based mannerisms and physical gestures of the real-life teacher.

In some aspects, the techniques described herein relate to a method, wherein the speech-based mannerisms includes one or more of frequency of pauses, length of the pauses, talking speed, tone, and diction.

In some aspects, the techniques described herein relate to a method, wherein the physical gestures include body part movement, facial feature movement, and physical interactions.

In some aspects, the techniques described herein relate to a method, wherein the physical interactions includes writing information on a surface.

In some aspects, the techniques described herein relate to a method, wherein the teaching avatar is trained to making a writing gesture that corresponds to writing the script.

In some aspects, the techniques described herein relate to a method, wherein the script includes questions to ask the at least one student.

In some aspects, the techniques described herein relate to a method, further including: receiving a user query; generating a response to the user query; and inserting the response to the script for the teaching avatar to recite.

In some aspects, the techniques described herein relate to a method, wherein the computing device is a hologram projector device.

In some aspects, the techniques described herein relate to a method, wherein the teaching avatar appears as a human, wherein the class attribute includes an ethnic background of the at least one student, and wherein setting the visual appearance of the teaching avatar includes adjusting an ethnicity of the human to match the ethnic background of the at least one student.

In some aspects, the techniques described herein relate to a method, wherein adjusting the ethnicity of the human includes adjusting at least one physical characteristic of the teaching avatar based on known physical characteristics of humans belonging to the ethnic background, wherein the at least one physical characteristic includes facial features, hair texture, skin color, and body type.

In some aspects, the techniques described herein relate to a method, wherein the teaching avatar appears as a human, wherein the class attribute includes a gender preference, and wherein setting the visual appearance of the teaching avatar includes adjusting a gender of the human to accommodate the gender preference.

In some aspects, the techniques described herein relate to a method, wherein the class attribute includes a language preference, and wherein setting the audio configuration of the teaching avatar includes adjusting a language spoken by the teaching avatar to accommodate the language preference.

In some aspects, the techniques described herein relate to a method, wherein the course is a custom course generated using a user interface.

It should be noted that the methods described above may be implemented in a system comprising a hardware processor. Alternatively, the methods may be implemented using computer executable instructions of a non-transitory computer readable medium.

In some aspects, the techniques described herein relate to a system for generating a teaching avatar using machine learning, including: at least one memory; at least one hardware processor coupled with the at least one memory and configured, individually or in combination, to: train, using a first machine learning algorithm, a teaching avatar to recite information using speech-based mannerisms and physical gestures of a real-life teacher, wherein the training is performed with a training dataset including videos and transcripts of real-life teachers administering courses; receive a class attribute including information about at least one student of a course; set a visual appearance and an audio configuration of the teaching avatar based on the class attribute; generate, using a second machine learning algorithm, a script based on the course; and execute, on a computing device, the teaching avatar to recite the script with the speech-based mannerisms and physical gestures of the real-life teacher.

In some aspects, the techniques described herein relate to a non-transitory computer readable medium storing thereon computer executable instructions for generating a teaching avatar using machine learning, including instructions for: training, using a first machine learning algorithm, a teaching avatar to recite information using speech-based mannerisms and physical gestures of a real-life teacher, wherein the training is performed with a training dataset including videos and transcripts of real-life teachers administering courses; receiving a class attribute including information about at least one student of a course; setting a visual appearance and an audio configuration of the teaching avatar based on the class attribute; generating, using a second machine learning algorithm, a script based on the course; and executing, on a computing device, the teaching avatar to recite the script with the speech-based mannerisms and physical gestures of the real-life teacher.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for generating custom courses on a user interface (UI) using machine learning.

FIG. 2A is a diagram illustrating a GUI accepting a topic selection.

FIG. 2B is a diagram illustrating a GUI accepting reference materials for a new topic.

FIG. 3 is a diagram illustrating the GUI accepting subtopic selections.

FIG. 4A is a diagram illustrating the GUI displaying a generated course.

FIG. 4B is a diagram illustrating the GUI displaying an updated course based on a duration input.

FIG. 4C is a diagram illustrating the GUI displaying an updated course based on a difficulty input.

FIG. 5 illustrates a flow diagram of a method for generating custom courses on a user interface using machine learning.

FIG. 6 is a block diagram illustrating a method for updating a GUI displaying content related to a topic based on user preference.

FIG. 7 is a diagram illustrating an exemplary teaching avatar.

FIG. 8 is a diagram illustrating another exemplary teaching avatar.

FIG. 9 is a block diagram illustrating a method for generating a teaching avatar using machine learning.

FIG. 10 presents an example of a general-purpose computer system on which aspects of the present disclosure can be implemented.

FIG. 11 is a block diagram illustrating a system for training course generator to generate custom courses according to aspects of the present disclosure.

### DETAILED DESCRIPTION

Exemplary aspects are described herein in the context of a system, method, and computer program product for generating a teaching avatar using machine learning. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes various aspects of conveying educational content via a user interface (UI). One aspect involves generating a custom course based on user preference. A second aspect involves teaching the custom course using a teaching avatar. The teaching avatar is a part of the GUI in this scenario.

In some aspects, the teaching avatar is generated using a dedicated hologram projector and in other aspects, the teaching avatar is generated on the same device that displays the GUI. In the latter case, the teaching avatar may be depicted using virtual reality, augmented reality, or mixed reality technology. Similarly, the teaching avatar may be depicted in a two-dimensional format within the display of the computing device depicting the custom course.

The teaching avatar may be configured to administer one or more courses. For example, the teaching avatar may read/describe the content found in the custom course. A teaching avatar may further be programmed with various elements of adaptive learning. For example, the teaching avatar may monitor for statements and questions from one or more students and provide an appropriate response. Furthermore, the teaching avatar may ask questions to students and administer quizzes and tests. By doing so, the teaching avatar can analyze, in real time, the degree of a student's understanding of the material and automatically adjust the duration and contents of the course.

In some aspects, the teaching avatar can be customized by the teacher or student to speak in different languages or have certain ethnic or gender-specific appearances. Thus, the teaching avatar may serve as a lecturer (e.g., a teacher) that can write on a display (e.g., a digital whiteboard). This may be better than simply showing slides and helps student focus and process information better. When a student interacts with the avatar (e.g., by asking a question), the avatar may enter an interactive tutor mode and try to answer student's question and explain the material using different methods (e.g., examples, problem solving, etc.). In general operation, the teaching avatar uses the main course's structure to explain material, but when responding to user's question in interactive tutor mode, the avatar uses supplemental branches of the course structure containing supplemental materials. During this interaction, the student can type, speak and even draw on a whiteboard to communicate with the avatar, and the avatar is configured to speak, write, and draw in response.

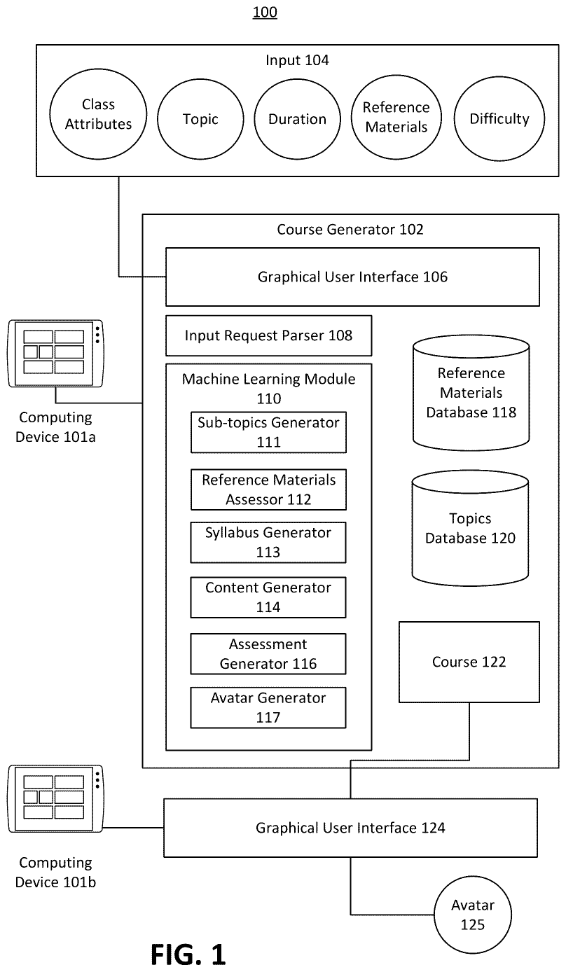

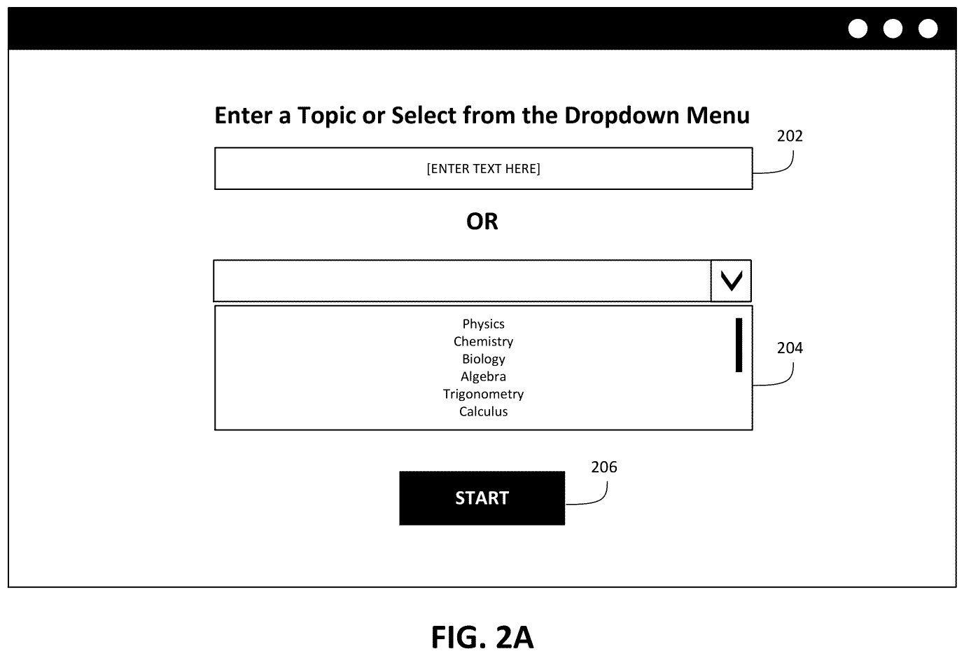

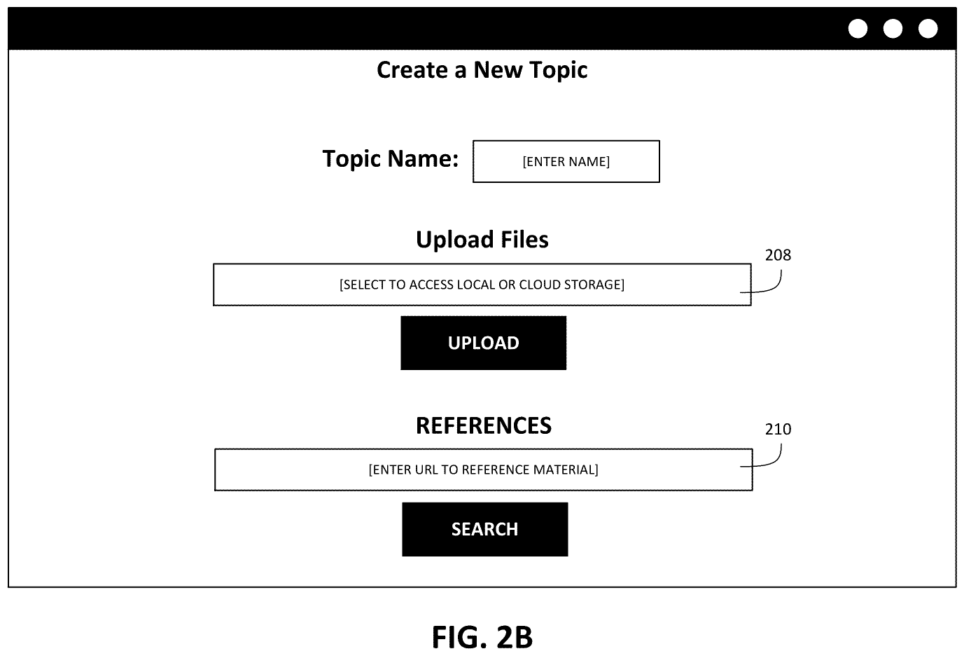

FIG. 1 is a block diagram illustrating system 100 for generating custom courses on a GUI using machine learning. In particular, system 100 features course generator 102, which may be a software installed on or accessed (e.g., via a virtual machine, container, web application) on computing device 101a. Course generator 102 includes a GUI 106, which is described in FIGS. 2-5, input request parser 108, machine learning module 110, reference materials database 118, and topics database 120. Course generator 102 is configured to generate course 122 for display on GUI 106. In some aspects, course generator 102 may transmit course 122 to user interface (UI) 124, which is part of a client application associated with course generator 102. GUI 124 may be generated by computing device 101b. For example, computing device 101a may be a device belonging to an educator (e.g., a teacher, a tutor, etc.) and computing device 101b may be a device belonging to a student that is taught by the educator. Alternatively, course 122 may be generated by a student on GUI 106 for self-learning.

The present disclosure discusses the use of artificial intelligence (AI) (e.g., large language models (LLM)) to create courses for teachers. For example, a teacher may indicate a topic (e.g., introduction to physics) and duration (e.g., 30 hours) of the course and may provide third party materials (e.g., textbooks, scientific papers, presentations, videos, media, etc.) to include in the course using GUI 106. Machine learning module 110 comprising one or more machine learning models (e.g., sub-topics generator 111, reference materials assessor 112, syllabus generator 113, content generator 114, and assessment generator 116) may analyze the user specified sources, as well as other known sources (e.g., stored in reference materials database 118), to generate a syllabus for the course that includes various topics and subtopics. The machine learning module may further fill each lesson of the course with content generated based on the AI analysis of the source materials. All this may be assembled into a book or multiple slide presentations, which serve as the output of the machine learning module 110.

In some aspects, course generator 102 uses a 3-step generation of the course. First, course generator 102 generates a syllabus, which is a organization scheme providing a course's structure, using an LLM that receives a description, reference materials, and other instructions from the user. The course structure includes topics, concepts (used interchangeably with sub-topics), and activities (used interchangeably with assessments). Second, course generator 102 enables the user to revise and edit the syllabus. Lastly, course generator 102 generates content for the course (e.g., including learning activities for each sub-topic).

In some aspects, course generator 102 receives, from the user, a description of the course (e.g., one or more of a title, a course syllabus, learning outcomes, duration, and other parameters/criteria). Course generator 102 may also receive, from the user, external source materials for course generation (e.g., books, articles, presentations, lectures, multimedia, etc.). Course generator 102 may even receive, from the user, additional instructions for fine-tuning an LLM of machine learning module 110 such as rules for creation of the course (e.g., paraphrase external materials or use direct quotes, add homework or quiz after each lecture, example of materials that LLM should use to generate the course, but not use in the course, such as user's old lectures/courses that show the preferred structure of feel of the course, but whose contents should not be used in the new course).

Course generator 102 is very interactive, proactive, iterative. For example, course generator 102 periodically/continuously offers the user ways to improve the course and does not wait for the user to ask it to do something or ask questions. Course generator 102 analyzes user-provided materials using an LLM, checks an accuracy of external materials, whether the materials are up-to-date, checks the authenticity/trustworthiness of the external materials, checks for the lack of inconsistencies between materials, and checks levels of complexity/depth/quality of external materials. Course generator 102 then generates the course using an LLM by extracting topics/concepts/activities from external materials, and generating learning outcomes or presentations, dividing the course into lectures based on user instructions (e.g., typical course includes of 15-20 lectures). Course generator 102 further outputs a course structure including a syllabus with topics, and for each topic, a set of concepts covered by the given topic and learning activities or placeholders for learning activities, which can be later filled with actual learning activities (e.g., homework, quizzes, tests, projects, etc.). Course generator 102 may further suggest to the user various learning activities for the course. It should be noted that, unlike artificial-intelligence chatbots, course generator 102 generates a course structure and then interactively suggests to the user how to fill it with various content extracted from external materials provided by the user and based on instructions specified by the user. This provides a greater level of customization to the course and improves its quality.

In an exemplary aspect, course generator 102 populates topics database 120. Topics database 120 includes a plurality of topics (e.g., “biology,” “chemistry,” “physics,” etc.), each of which include a plurality of sub-topics. For example, the user may provide a plurality of reference materials to course generator 102. Reference materials include, but are not limited to, textbooks, non-fiction books, webpages, e-books, videos, graphics, research papers, patents, etc. In some aspects, the user may provide, to course generator 102, a copy of the reference material(s) or may provide links to the reference material(s) for course generator 102 to web crawl. The user may label the reference materials as part of a topic. For example, the user may type in a topic in GUI 106, and upload reference materials (see FIG. 2B). All provided reference materials are stored in reference materials database 118.

Given a set of reference materials for the topic, machine learning module 110 is configured to identify various sub-topics of the topic. For example, if the topic is “poetry,” a sub-topic may be a particular type of poetry or a famous poet. In order to identify the sub-topics, course generator 102 may refer to the chapter titles of the reference materials (e.g., video names, slide titles, textbook chapter titles, etc.) and identify each unique title as a sub-topic. In another approach, sub-topics generator 111 of machine learning module 110 may be used to execute an algorithm such as Latent Dirichlet Allocation (LDA).

In some aspects, input request parser 108 may clean the provided/linked text data by removing stop words, punctuation, and irrelevant characters. Input request parser 108 may further break down the cleaned text into individual words or tokens. This step prepares the data for analysis on a word level. Sub-topics generator 111 may then create a document term matrix (DTM) that represents the frequency of each term (word) in each document (e.g., textbook, webpage, etc.). Each row of the DTM may correspond to a document, and each column may correspond to a unique term, with the matrix cells including the frequency of each term in the respective document. Sub-topics generator 111 may then apply the LDA algorithm to the DTM. LDA assumes that each document is a mixture of sub-topics, and each sub-topic is a mixture of words. The algorithm iteratively assigns words to sub-topics based on the distribution of topics across documents. Furthermore, sub-topics generator 111 assigns each document a probability distribution over topics, and each word is assigned to a specific sub-topic with a certain probability. Sub-topics generator 111 may identify the most probable sub-topics for each document based on the assigned probabilities. This step involves looking at the words with the highest probability in each sub-topic and interpreting them to label the sub-topics.

Using the method described above, sub-topics generator 111 is able to identify the most common words in each topic/subtopic. Said words are stored in a glossary of the topic, which is further recorded in topics database 120. In particular, the glossary indicates multiple words and a weight of each word. The weight of the word may be determined based on a frequency at which each word appears in the reference materials. For example, for a sub-topic such as “photosynthesis” in the topic “biology,” terms such as “sunlight” and “carbon dioxide,” which appear frequently in relation to “photosynthesis” in the reference materials may be weighted higher than “night,” and “hydrogen,” which appear less frequently. For example, the weight of “sunlight” may be 1.1, while the weight of “night” may be 0.2. This suggests that in a summary, the words with higher weights should be preferred for inclusion than words with lower weights. This may be because less common words are probably specific to one textbook or niche ideas.

Reference materials assessor 112 of machine learning module 110 may also be configured to assign a quality level to each reference material in reference materials database 118. A quality level represents a reliability and general preference of a textbook as expressed in a quantitative value. For example, a university level textbook on “biology” may be a high quality material, where as a fiction novel about “biology” may be a low quality material. Assessing the quality of multiple reference materials using machine learning involves defining and extracting features that represent various aspects of a material's quality. Reference materials assessor 112 may define objective metrics (e.g., readability scores, grammatical correctness, and the complexity of sentence structures) and subjective metrics (e.g., metrics based on expert reviews, user ratings, or feedback from educators and students) for each reference material. Using these metrics, reference materials assessor 112, which may be a trained classification model, may output a quality level for each reference material. In some aspects, a quality level may be a quantitative value (e.g., a rating out of 10) or a qualitative value (e.g., “low,” “medium,” “high,” etc.).

Reference materials assessor 112 of machine learning module 110 may also be configured to assign a difficulty level to each reference material in reference materials database 118. For example, a university level textbook on “biology” may be a high difficulty material, where as an elementary school textbook about “biology” may be a low difficulty material. Reference materials assessor 112 may define metrics such as complexity of sentence structures, word length, recommended age groups, target grade level, etc., for each reference material. Using these metrics, reference materials assessor 112, which may be a trained classification model, may output a difficulty level for each reference material. In some aspects, a difficulty level may be a quantitative value (e.g., a rating out of 10) or a qualitative value (e.g., “low,” “medium,” “high,” etc.).

Course generator 102 stores reference materials and their respective quality levels and difficulty levels in reference materials database 118. It should be noted that prior to first use of course generator 102 for generating courses, the topics database 120 and reference materials database 118 needs include at least one topic and at least one reference material pertaining to the topic. A developer of course generator 102 may populate the software with multiple topics and reference materials for each topic. Afterwards, users can add topics and reference materials individually. In some aspects, topics database 120 and reference materials database 118 may be synchronized across multiple computing devices running course generator 102. For example, multiple schools or communities may share newly created topics and reference materials over a cloud database. As a result, any of a topic, reference material, course, etc., generated on one computing device may be transmitted by course generator 102 to a different computing device over a network (e.g., a local area network (LAN), a wide area network (WAN), etc.) for display on a GUI.

Suppose that a user launches course generator 102 on computing device 101a to generate a course 122 on GUI 106. In an exemplary aspect, GUI 106 receives input 104, which may include a topic and, in some aspects, any of a duration, a difficulty, and preferred reference materials. For example, the topic in input 104 may be “biology.” Input request parser 108 may search for the topic in topics database 120. In response to finding a match, course generator 102 may output course 122 on GUI 106.

In some aspects, input 104 further includes class attributes. These attributes indicate the size of the class, the ethnicities of the students, the location where the class is held, and available devices for outputting an avatar 125. As shown in FIG. 1, machine learning module 110 includes avatar generator 117. Creating a teaching avatar 125 using avatar generator 117 involves a sophisticated process of data collection, model training, and fine-tuning to ensure the avatar 125 effectively emulates a teacher teaching a specific course.

During data collection and preparation, avatar generator 117 gathers a diverse range of teaching-related data, including lecture videos, transcripts, course materials, and teaching styles from various educators. Avatar generator 117 annotates the data to identify key teaching behaviors, expressions, gestures, and speech patterns of teachers, professors, lecturers, etc. For example, avatar generator 117 may identify multiple video clips in which teachers take pauses after describing certain concepts and ask students if they have questions about what was discussed. This is a habit that the avatar 125 can be trained to emulate. In some aspects, avatar generator 117 cleans and preprocesses the data to remove noise, standardize formats, and ensure consistency across different sources.

Avatar generator 117 serves as a machine learning sub-module that is designed to generate life-like avatars based on the collected teaching data. Avatar generator 117 may fine-tune the avatar architecture and parameters to optimize for teaching-specific characteristics, such as voice modulation, facial expressions, body language, and instructional delivery. Avatar generator 117 may even employ techniques like transfer learning to leverage pre-trained models and adapt them to the teaching domain, speeding up the training process and improving performance.

In terms of avatar configuration and customization, avatar generator 117 may configure the teaching avatar 125 to embody the desired persona, including gender, age, ethnicity, clothing style, and other visual attributes that align with the target audience and teaching context. These preferences may be listed in the class attributes of input 104. For example, if the class is held in a classroom in a business school, the avatar 125 may have a business formal attire. Avatar generator 117 may thus customize the avatar's appearance to ensure it reflects the diversity and inclusivity of the teaching community and resonates with learners from different backgrounds.

A course also has several means of configuration including, but not limited to, the selection of topic, selection of sub-topics, selection of reference materials, selection of duration, selection of difficulty, glossary customization, etc. In some aspects, some configurations may be set on a course level (e.g., a duration or difficulty of an entire course) and some configurations may be set on a sub-topic level (e.g., a duration of a particular lesson on a sub-topic). In response to receiving a generic input (e.g., “biology”), course generator 102 may generate course 122 using default configurations (e.g., a default set of sub-topics, difficulty, duration, etc.). In some aspects, the default configurations may be set by course generator 102 based on user preferences. For example, when creating a user profile, the user may indicate that he/she is in the 12th grade. Based on this information, course generator 102 may set the difficulty of a course to “high school” level, may set the duration to 170 hours (accounting for an hour per school day), and may use high school textbooks to generate course content.

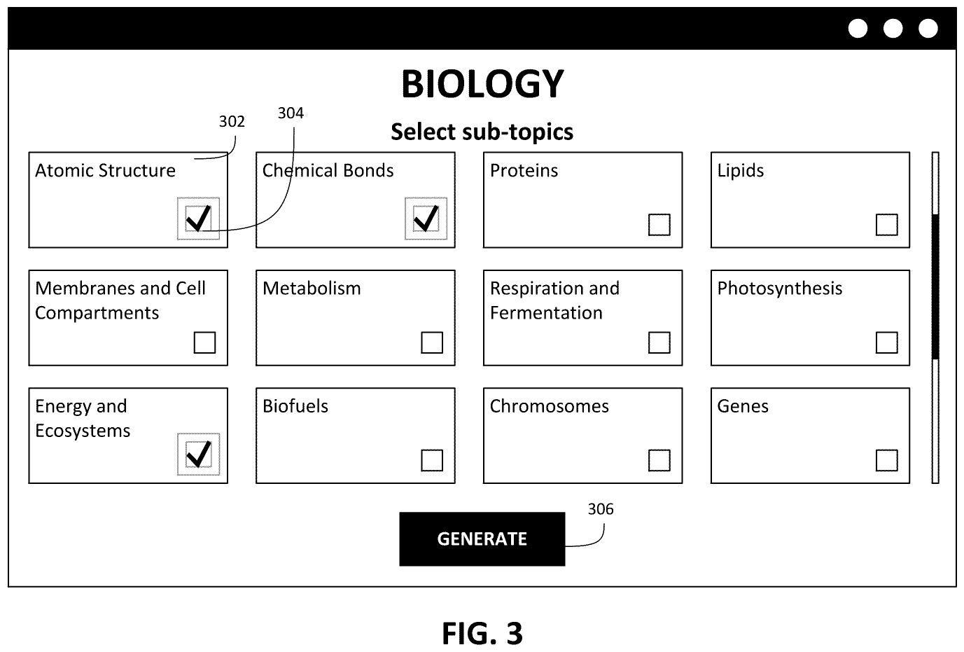

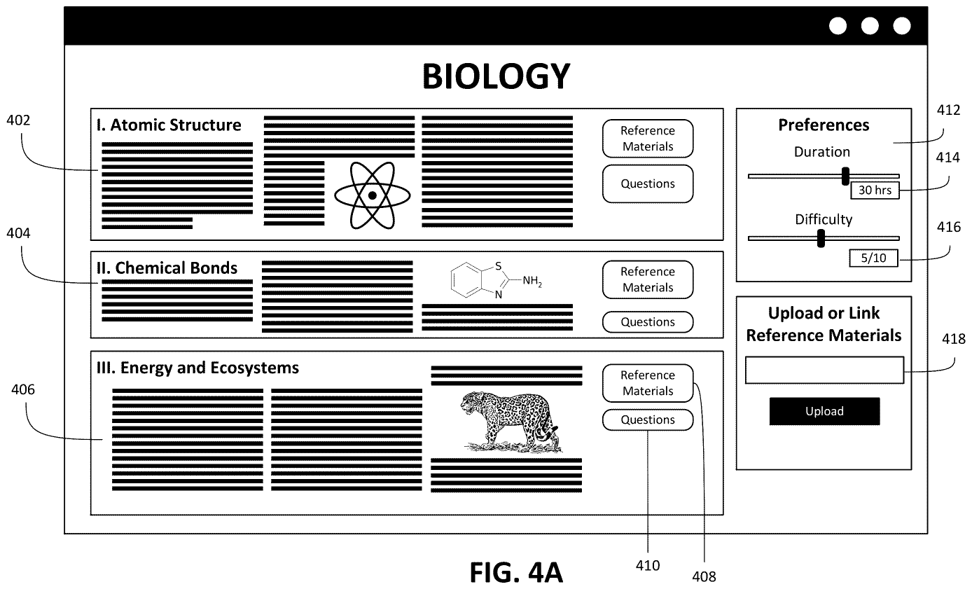

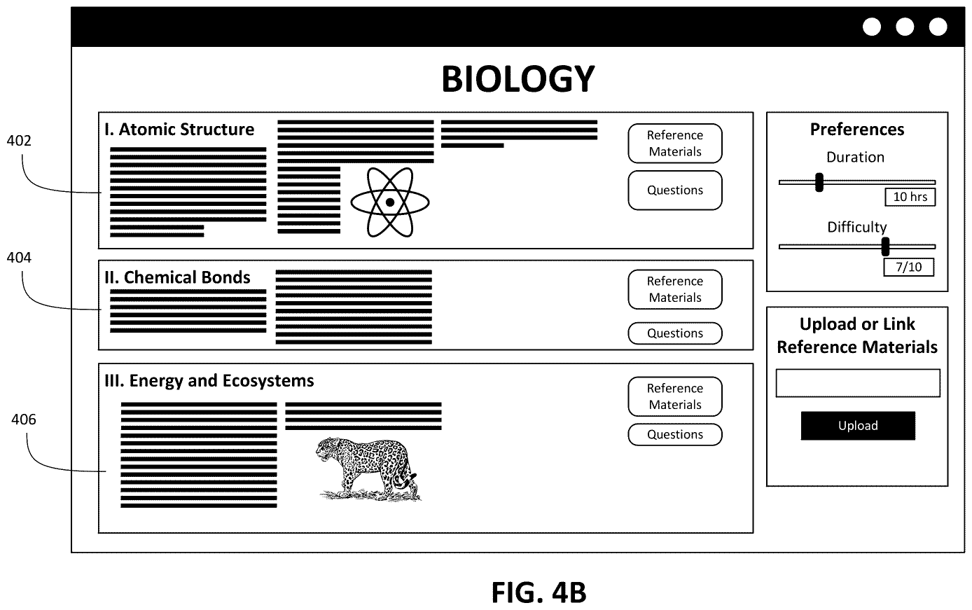

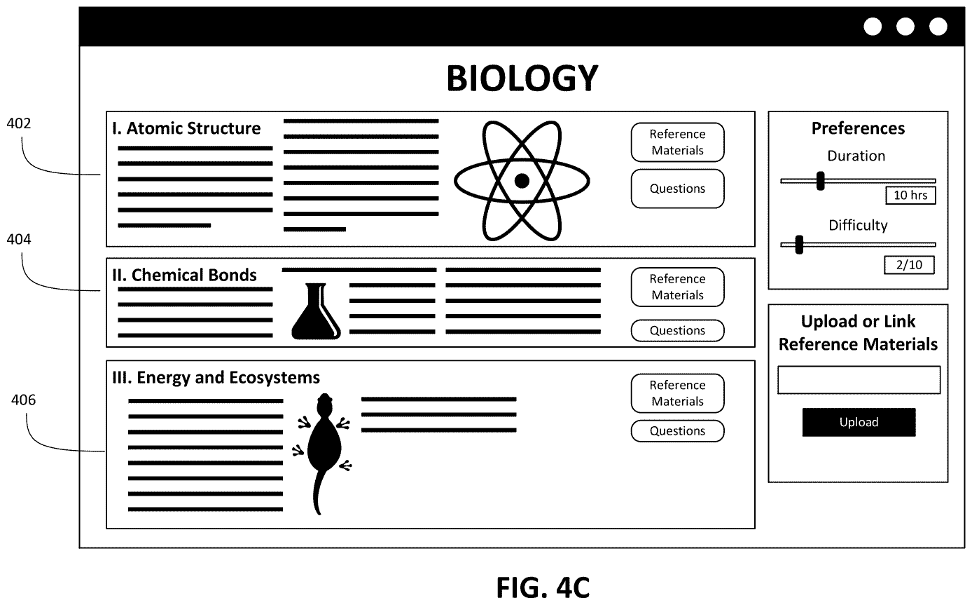

In some aspects, course generator 102 may generate queries on GUI 106 to acquire more preferences by the user. For example, course generator 102 may generate a prompt that requests the user to select the sub-topics of interest (see FIG. 3). Course generator 102 may also generate panels that include configuration options (see FIG. 4A). For example, a user may be able to adjust the difficulty or duration of a course, while course generator 102 adjusts the content generated for a particular sub-topic.

In terms of course generation, syllabus generator 113 is configured to generate a structure of the course. Based on the selection of a topic, sub-topics, duration, difficulty, reference materials, etc., syllabus generator 113 outputs a plurality of course attributes. For example, the course attributes may indicate that the course has three sub-topics to be covered over nine hours on an intermediate difficulty. To achieve a nine hour duration, syllabus generator 113 allocates three hours for each sub-topic. To achieve three hours for each sub-topic, syllabus generator 113 limits a word limit of the content to 24000 (accounting for 200 word per minute reading speed), an assessment limit of 20 questions, and a media limit (e.g., a video) of 20 minutes. To achieve the difficulty constraints, reference materials matching the difficulty level are specified. For simplicity, all of these configurations are kept the same for each sub-topic in this example. However, a user may specify sub-topic level preferences, which may change these numbers. Furthermore, word limits may change based on the difficulty level as well as both duration and difficulty may affect each other. For example, at an elementary school level, the reading speed is significantly slower and comprehension skills are lower than at a university level. Accordingly, syllabus generator 113 may output lower word limits to accommodate.

In order to produce accurate structures, machine learning module 110 trains syllabus generator 113, which may be a regression model, using a training dataset that includes several input vectors and corresponding output vectors. The input vectors may each include user preference fields such as topic, sub-topic count, duration, difficulty, sub-topic level preferences, etc. The corresponding output vectors may each include course attribute fields with the ideal word limits, media limits, question limits, etc., per sub-topic. By training syllabus generator 113 to generate the output vectors based on the input vectors, syllabus generator 113 is able to recommend a plurality of course attributes for any set of course configurations provided in input 104.

Content generator 114 receives the course attributes and generates content for each sub-topic. In particular, the content comprises a summary, graphics, media, assessments (e.g., questions, projects, etc.), and recommended supplemental readings generated using one or more reference materials.

Generating summaries from multiple reference materials in reference materials database 118 using machine learning involves leveraging natural language processing (NLP) and text summarization techniques. In an exemplary aspect, content generator 114 may perform tokenization on each of the reference materials above a threshold quality level and that match a difficulty level preferred/specified by the user. Content generator 114 converts the tokenized text into numerical representations using techniques like Term Frequency-Inverse Document Frequency (TF-IDF) or word embeddings (e.g., Word2Vec, GloVe). This step captures the semantic meaning of words. In some aspects, content generator 114 may employ one or both of abstractive and extractive summarization approaches. Abstractive summarization involves generating new sentences to convey the summary, while extractive summarization selects and rearranges existing sentences.

In a supervised learning approach, content generator 114 is trained on labeled data with summaries corresponding to the reference materials. Accordingly, content generator 114 learns the relationship between the content and its corresponding summary. In an unsupervised learning approach, content generator 114 may use graph-based methods (e.g., TextRank) or clustering algorithms to identify and select the most important sentences. The length of the summary is bound to the course attribute indicated by syllabus generator 113. For example, if the word limit is 24000, the summary will include sentences extracted and/or abstracted from the reference materials that include no more than 24000 words. Because the reference materials are filtered based on quality and difficulty, content generator 114 generates tailored summaries for the user.

In an exemplary aspect, when selecting the sentences to include in the summary, content generator 114 refers to the glossary in topics database 120—specifically the glossary terms corresponding to a particular sub-topic. The weights of the words indicate which words are more important than others. Thus, the sentences extracted from reference material are likely to include words with higher weights. Likewise, self-generated sentences are likely to include words with higher weights. In some aspects, a user may access the glossary and adjust weights. In fact, a user may opt to add words and remove words depending on their learning preferences.

In some aspects, the extracted sentences from the reference materials may include mentions of graphics. For example, a textbook passage may refer to a textbook image. Accordingly, content generator 114 includes the mentioned graphic in the generated content. In another example, a website may include a link to a video on a video streaming website. Accordingly, content generator 114 includes the link to the video in the generated content.

Assessment generator 116 is configured to generate one or more of questions, short quizzes, tests, lab projects, etc., based on the generated content. For example, assessment generator 116 may be a generative neural network that receives the summary generated by content generator 114 and creates questions with answers found in the summary. If the summary says “the mitochondria is an organelle in which respiration and energy production occur,” assessment generator 116 may generate the question “which organelle is responsible for respiration and energy production?”. In some aspects, assessment generator 116 may identify questions found in the reference materials associated with the sub-topic. For example, if the summary includes information about the mitochondria, assessment generator 116 may identify a question in the reference material about the mitochondria. In some aspects, assessment generator 116 compares the sentences in the summary to the sentences in the questions. Based on a correspondence, assessment generator 116 determines whether the question is a candidate for inclusion in the generated content. It should be noted that the number of questions or types of assessments produced by assessment generator 116 is indicated in the course attributes generated by syllabus generator 113.

In some aspects, the avatar 125 generated by avatar generator 117 outputs these assessments and questions to improve the interaction between students and the custom course. By making the course more interactive, comprehension of difficult concepts can be improved. In general, avatar generator 117 may integrate the teaching avatar 125 with the course content and curriculum by mapping specific topics, concepts, and learning objectives to corresponding instructional sequences and dialogues. In fact, avatar generator 117 may design interactive scenarios and teaching simulations that allow learners to engage with the avatar 125 in realistic teaching environments, such as virtual classrooms or interactive multimedia platforms. For example, if the avatar 125 is viewed as a three-dimensional object (e.g., either via a headset or a hologram projector device), there are certain demonstrations that the avatar 125 can perform to improve comprehension. Suppose that the avatar 125 is describing the structure of a DNA. Instead of displaying a two-dimensional image of a DNA helix, the avatar 125 may present a three-dimensional helix. By presenting demonstrative objects that describe a sub-topic, the avatar 125 improves interaction with the GUI. Because there is no limit on what can be visually generated, the avatar 125 can be accompanied with complex objects that even a real-life teacher would not be able to effectively present.

In some aspects, avatar generator 117 may conduct rigorous evaluation and validation tests to assess the teaching avatar's performance, usability, and effectiveness in delivering course material and engaging learners. For example, avatar generator 117 may collect feedback from both educators and students to identify areas for improvement and iteration, iteratively refining the avatar's teaching capabilities based on user input and real-world usage scenarios. For example, if students indicate that the avatar 125 talks to fast or is difficult to understand, the audio speed or voice of the avatar 125 may be adjusted.

In some aspects, course generator 102 is equipped with sophisticated feedback algorithms that actively monitor student progress and adapt the generated content in real-time. The feedback algorithms recognize areas where students excel or struggle (e.g., like in differentiating between their grasp on derivatives and integrals in calculus). Based on this insight, course generator 102 may proactively offer supplementary modules, interactive tutoring sessions, or even adjust the main course content to better suit the student's learning pace and style. These real-time adjustments are powered by an intricate analysis of student performance, feedback, and learning patterns-ensuring that each student's learning journey is as effective and personalized as possible.

In general, machine learning module 110 may comprise one or more machine learning algorithms, which can broadly be categorized into three main types: supervised learning, unsupervised learning, and reinforcement learning.

Supervised learning is effective for tasks such as classification (assigning inputs to predefined categories) and regression (predicting continuous values). It relies on the availability of labeled data for both training and evaluation phases. In supervised learning, machine learning module 110 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, machine learning module 110 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, machine learning module 110 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine learning module 110 refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

Unsupervised learning is valuable for tasks where the goal is to explore the inherent structure of the data, identify hidden patterns, or pre-process data for further analysis. It doesn't require labeled examples but relies on the algorithm's ability to discern meaningful structures within the input data. Unsupervised learning deals with unlabeled data, aiming to discover patterns, structures, or relationships within the dataset. Clustering and dimensionality reduction are common tasks in unsupervised learning, helping to reveal inherent structures without predefined target labels. The typical process for unsupervised learning includes: data collection, analysis (e.g., using clustering, dimensionality reduction, etc.) and association. For example, machine learning module 110 receives a dataset including only input features without corresponding output labels. Machine learning module 110 then performs exploratory data analysis to understand the inherent structure of the data. Common techniques in this analysis include statistical measures, clustering, and dimensionality reduction. For example, in clustering, the algorithm groups similar data points together based on certain features. Algorithms including, but not limited to, k-means clustering and hierarchical clustering are commonly used for grouping. In dimensionality reduction, the algorithm reduces the number of input features while retaining essential information. For example, the algorithm may use techniques like Principal Component Analysis (PCA) or t-distributed Stochastic Neighbor Embedding (t-SNE) for dimensionality reduction. During the association phase, the algorithm discovers relationships or associations between variables in the analyzed data. In some aspects, unsupervised learning is used in generative neural networks (e.g., generative adversarial networks (GANs)) to generate new data points similar to the existing dataset once the characteristics of the existing dataset are learned.

Reinforcement learning is applied in scenarios where the optimal decision-making strategy is learned through trial and error, without explicit guidance. It finds applications in various domains, including robotics, game playing, and autonomous systems. More specifically, reinforcement learning involves an agent learning to make decisions by interacting with an environment. The agent receives feedback in the form of rewards or penalties based on its actions, allowing it to learn optimal strategies through trial and error. The primary components of reinforcement learning are as follows: agent, environment, state, action, reward, exploration and exploitation, learning policy, and value function. An agent is the entity that takes actions in the environment. It's the learner in the system. The environment is the external system with which the agent interacts. It provides feedback to the agent based on the actions taken. The state is a representation of the current situation or configuration of the environment. Actions are the moves or decisions that the agent can take within the environment. A reward is a numerical signal that indicates the immediate benefit or cost of the agent's action. The agent's objective is to maximize the cumulative reward over time. The reinforcement learning process typically involves the following steps. The agent explores the environment to discover the most rewarding actions (exploration) and exploits its current knowledge to take actions it believes will yield the highest cumulative reward (exploitation). The agent learns a policy, which is a strategy that maps states to actions, based on the observed rewards and its exploration-exploitation trade-offs. The agent may also learn a value function, estimating the expected cumulative reward from a given state or state-action pair.

In machine learning, training involves optimizing the model's parameters to minimize a chosen objective function, often a loss function. Some training formulas and concepts that machine learning module 110 may execute include linear regression loss, logistic regression loss, reinforcement learning, and neural network loss.

For linear regression, Mean Squared Error (MSE) is a common loss function.

$$MSE = \frac{1}{n} {\sum }_{i = 1}^{n} {( {y}_{i} - {\hat{y}}_{i} )}^{2} ,$$

where yi is the true output, y\hat{ }i is the predicted output, and n is the number of samples. For binary classification in logistic regression, the Binary Cross-Entropy Loss is frequently used.

$$Binary Cross - Entropy = - \frac{1}{n} {\sum }_{i = 1}^{n} [ {y}_{i} log ( {\hat{y}}_{i} ) + ( 1 - {y}_{i} ) log ( 1 - {\hat{y}}_{i} )$$

where yi is the true label (0 or 1), y\hat{ }i is the predicted probability, and n is the number of samples. In neural networks, the cross-entropy loss is common for classification tasks.

$$Cross - Entropy = - \frac{1}{n} {\sum }_{i = 1}^{n} {\sum }_{j = 1}^{C} {y}_{ij} log ( {\hat{y}}_{ij} ) ,$$

where yij is the true probability of class j, y\hat{ }ij is the predicted probability, n is the number of samples, and C is the number of classes.
In reinforcement learning, the objective is often to maximize the expected cumulative reward.

The Q-learning update rule is an example:

$$Q ( s , a ) ← Q ( s , a ) + α [ r + γ {max}_{{a}^{′}} Q ( {s}^{′} , {a}^{′} ) - Q ( s , a ) ] ,$$

where Q (s,α) is the action-value function, α is the learning rate, r is the immediate reward, γ is the discount factor, s′ is the next state, and α′ is the next action.

These formulas represent the core optimization objectives in different machine learning scenarios, and the choice depends on the specific task and model architecture.

Machine learning module 110 may comprise one or more neural networks, which are a class of machine learning models inspired by the structure and functioning of the human brain. They consist of interconnected nodes, called neurons or artificial neurons, organized into layers. Neural networks are capable of learning complex patterns and representations from data. The neural network executed by machine learning module 110 may be one of the following: a feedforward neural network (FNN), convolution neural network (CNN), recurrent neural network (RNN), long short-term memory (LSTM) network, gated recurrent unit (GRU) network, autoencoder, generative adversarial network (GAN).

An FNN is the simplest form of neural network, where information travels in one direction—from the input layer through hidden layers to the output layer. An FNN is commonly used for tasks like classification and regression.

A CNN is specialized for processing grid-like data, such as images, and employs convolutional layers to learn spatial hierarchies of features, reducing the need for manual feature engineering. CNNs are well-suited for tasks like image classification, object detection, and image generation.

An RNN is designed for sequential data, where the order of inputs matters. An RNN includes loops in the network architecture to allow information to persist, and is useful for tasks like natural language processing, speech recognition, and time-series prediction.

A LSTM network is an extension of an RNN designed to overcome the vanishing gradient problem. LSTMs have memory cells that can store and retrieve information over long sequences, making them effective for capturing long-term dependencies in sequential data.

A GRU Network is similar to LSTMs and are another type of RNN with mechanisms to address the vanishing gradient problem. GRUs have a simpler architecture with fewer parameters compared to LSTMs.

An autoencoder is a type of neural network used for unsupervised learning and dimensionality reduction, and consists of an encoder that compresses input data into a lower-dimensional representation (encoding) and a decoder that reconstructs the original input from the encoding.

A GAN comprises a generator and a discriminator trained simultaneously through adversarial training. The generator aims to generate realistic data, while the discriminator tries to distinguish between real and generated data. A GAN is widely used for image and content generation tasks.

FIG. 2A is a diagram illustrating a GUI accepting a topic selection. The GUI in FIG. 2A corresponds to GUI 106 generated on computing device 101a. GUI 106 (as shown in FIG. 2A) displays text stating “enter a topic or select from the dropdown menu” and provides two input options right below. GUI 106 may receive a text input in textbox 202 (e.g., the user may enter the text “Biology”) or may receive a selection from the plurality of topics listed in menu 204 (e.g., the user may scroll through the menu and select “Biology”). GUI 106 receives confirmation of the selection via the selection of the “start” button 206.

FIG. 2B is a diagram illustrating a GUI accepting reference materials for a new topic. GUI 106 (as shown in FIG. 2B) displays text stating “create a new topic,” and provides field 208 where a user may upload reference materials. For example, GUI 106 may receive a collection of slide deck(s), text document(s), graphic(s), etc., that are uploaded by the user from a local storage (e.g., a local hard drive) or a cloud storage (e.g., an online data storage service). Additionally or alternatively, the user may provide Internet-based links (e.g., URL) to said references via field 210.

FIG. 3 is a diagram illustrating the GUI accepting subtopic selections. GUI 106 (as shown in FIG. 3) generates a plurality of sub-topics to include from the selected topic. For example, if GUI 106 receives a selection of “biology,” reference materials assessor 112 may extract the corresponding sub-topics from topics database 120. In FIG. 3, examples of sub-topics include “atomic structure,” “chemical bonds,” “proteins,” “lipids,” etc. Each sub-topic may be listed in a dropdown menu or as a table with multiple selectable elements. For example, in FIG. 3, GUI 106 presents the sub-topics as elements such as element 302 that includes a selection indicator 304. When the user selects a selection indicator 304 for a particular element, a graphic indicative of selection may be generated (e.g., a checkmark in the checkbox). After the user is satisfied with his/her selection(s), the user may select the “generate” button 306 to confirm the selection.

FIG. 4A is a diagram illustrating the GUI displaying a generated course. Subsequent to receiving selections of the topic and sub-topic, GUI 106 generates a course that includes an initial syllabus and initial course content. For example, factors such as duration and difficulty may be default values such as 30 hours and 5/10, respectively. As shown in FIG. 4A, GUI 106 displays panels 402, 404, and 406. Each panel is ordered in the manner indicated by the generated syllabus (e.g., “atomic structure,” followed by “chemical bonds,” followed by “energy and ecosystems”). Each panel includes course content, which includes any combination of text, graphics (e.g., images, videos, animations, etc.), interactive plug-ins (e.g., games, etc.), etc., extracted from the reference materials associated with the sub-topics. Each panel further includes reference materials button 408, which allows a user to access the reference materials directly, and may indicate the portions that the user is recommended to read/view/listen to in the reference materials. For example, the user may review panel 406, which includes the course content generated by content generator 114. The user may then select reference materials button 408, which directs the user to a website that includes recommended supplemental material to learn more about the sub-topic. Likewise, GUI 106 may receive a selection of questions button 410, which results in an output of questions generated by assessment generator 116.

In an exemplary aspect, GUI 106 displays preferences panel 412, which allows the user to customize the course displayed on GUI 106. For example, a user may adjust the duration associated with the course by entering a duration value in duration adjuster 414 (e.g., the user may enter a text input or slide the slider). The user may also adjust the difficulty of the course by entering a difficulty value in difficulty adjuster 416. The effects of changing course duration are seen by comparing FIG. 4A and FIG. 4B. The effects of changing course difficulty are seen by comparing FIG. 4B and FIG. 4C.

Lastly, the user may upload the reference material that he/she would like to incorporate in the content generated by content generator 114. For example, the user upload a slide deck via panel 418. Accordingly, the text, graphics, etc., shown in the panels 402, 404, and 406 may dynamically change to incorporate the contents of the uploaded slide deck. Similarly, the user may provide an Internet-based link to the reference material via panel 418.

FIG. 4B is a diagram illustrating the GUI displaying an updated course based on a duration input. As shown in FIG. 4A, GUI 106 displays the course comprising panels 402, 404, 406, and options for each panel via buttons such as buttons 408 and 410. As the user makes adjustments to the course using panels 412 and 418, GUI 106 is dynamically updated. In particular, data that is not relevant or does not accommodate the user's preferences is automatically hidden, whereas data that is relevant and accommodates the user's preferences is highlighted. In FIG. 4A, the duration of the course is set to 30 hours. In FIG. 4B, GUI 106 receives an adjustment that sets the duration to 10 hours. Accordingly, GUI 106 dynamically updates such that fewer text is shown. More specifically, the content from the references materials is summarized in a manner that fewer words are used to describe the sub-topic, fewer questions are included in assessments, and not as many reference materials are recommended. As a result, the user spends less time learning the information.

FIG. 4C is a diagram illustrating the GUI displaying an updated course based on a difficulty input. For example, in FIG. 4B, the text is reduced and the sub-topic is summed in fewer words. However, the difficulty remains constant. In FIG. 4C, GUI 106 receives an adjustment that sets the difficulty from 5/10 to 2/10 (e.g., making it easier to understand). As shown in panels, 402, 404, and 406, even less text is used and the images are slightly different (e.g., more cartoon-like). The difficulty may be adjusted slightly by explaining concepts in layman terms with simpler words (e.g., using the word “hard” instead of “challenging”). Alternatively, the difficulty may be adjusted greatly by using different reference materials to generate the content (as shown in FIG. 4C). For example, instead of using a university-level textbook, GUI 106 may display content summarized from an elementary school textbook covering the same sub-topic.

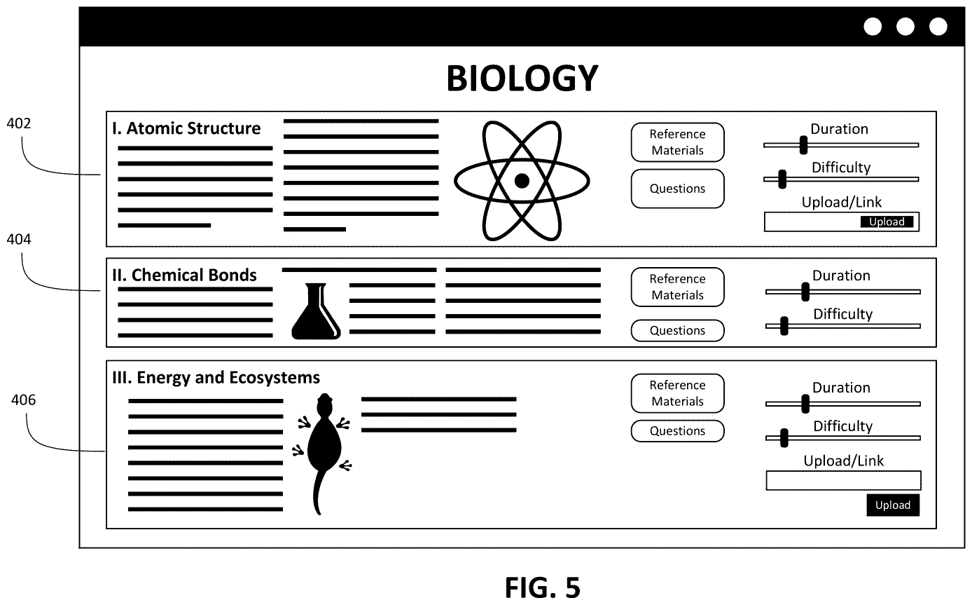

FIG. 5 is a diagram illustrating the GUI configuration options for the content generated for each sub-topic. As shown in FIG. 5, in each of panels 402, 404, 406, GUI 106 may display the options shown in panels 412 and 418. For example, the user may not be interested in adjusting the difficulty, reference materials, and/or duration of all courses globally, or may have preferences for each specific sub-topic. In some aspects, the user may indicate a particular difficult, duration, and/or reference material for each sub-topic, and GUI 106 may update the content automatically based on the selection. For example, the user may want to cover the topic of “atomic structure,” in two hours on an easier difficulty because the user or a student of the user does not understand the subject as easily as other sub-topics. In contrast, the user may want to spend only 30 minutes learning about “energy and ecosystems,” and is comfortable on an intermediate difficulty setting. The user may even upload specific reference materials for a specific sub-topic such as “energy and ecosystems,” or may link an e-book and specify pages (e.g., a chapter associated with “energy and ecosystems”) to extract/summarize information from.

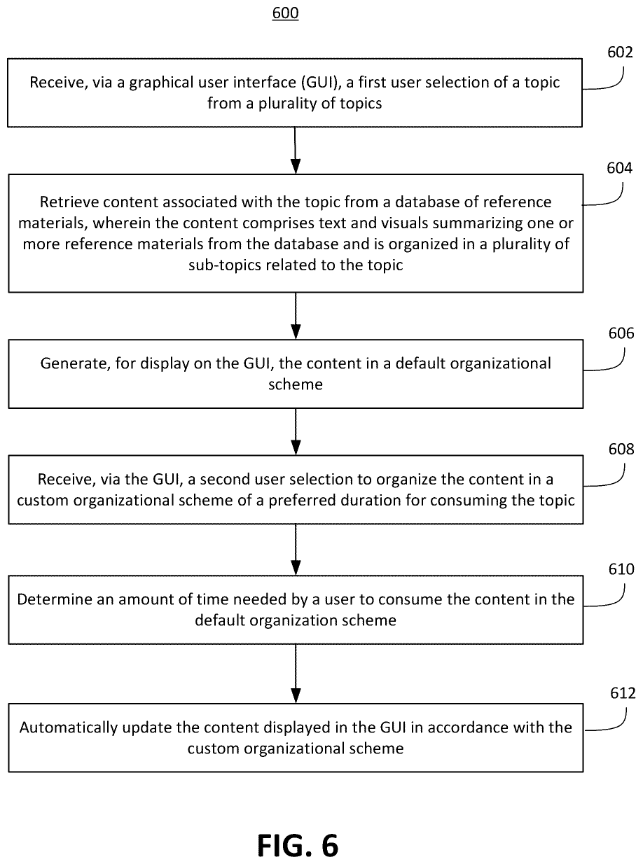

FIG. 6 is a block diagram illustrating method 600 for updating a GUI displaying content related to a topic based on user preference. At 602, course generator 102 receives, via GUI 106, a first user selection of a topic from a plurality of topics (as shown in FIG. 2A). At 604, content generator 114 retrieves content associated with the topic from a database of reference materials (e.g., reference materials database 118). The content includes text and visuals summarizing one or more reference materials from the database and is organized in a plurality of sub-topics related to the topic. In some aspects, the content is a course.

At 606, course generator 102 generates, for display on the GUI 106, the content in a default organizational scheme. In some aspects, an organizational scheme is a syllabus indicative of an order in which the plurality of sub-topics are presented, and an amount of text, graphics, and assessments for each sub-topic.

In some aspects, information of each sub-topic in the plurality of sub-topics is outputted in a different visual panel (e.g., panels 402, 404, and 406). In some aspects, a visual panel of a respective sub-topic includes options to adjust a duration and a difficulty level of the respective sub-topic. In some aspects, a visual panel of a respective sub-topic includes an option to provide a reference material from which information about the respective sub-topic is exclusively extracted. This is shown in FIG. 5.

At 608, course generator 102 receives, via the GUI 106, a second user selection to organize the content in a custom organizational scheme of a preferred duration for consuming the topic. For example, the user may enter, as shown in FIG. 4A, a duration value in duration adjuster 414 (e.g., the user may enter a text input or slide the slider).

At 610, course generator 102 determines an amount of time needed by a user to consume the content in the default organization scheme. For example, the default organization scheme may be have a default duration of 30 hours. This indicates that in order to complete the course, the user will need about 30 hours. This duration includes reading the text in the content, viewing the photos/videos, and completing the assessments, all of which may be required to consume the content in its entirety.

At 612, course generator 102 automatically updates the content displayed in the GUI in accordance with the custom organizational scheme. For example, course generator 102 may add additional content to the content when the amount of time is less than the preferred duration. In another example, course generator 102 may filter out existing content from the content when the amount of time is greater than the preferred duration. Suppose that the preferred duration is 10 hours. As shown in FIG. 4B, because the duration is less than the default duration, the amount of content shown in the panels 402, 404, and 406 decreases.

In some aspects, automatically updating the content displayed in the GUI in accordance with the custom organizational scheme involves executing a first machine learning algorithm trained to generate, for an input duration, a word limit of text in the content, a media limit of graphics in content, and an assessment limit of questions in the content. Course generator 102 may then execute a second machine learning algorithm trained to summarize the one or more reference materials into the content comprising an updated amount of text capped at the word limit, an updated amount of graphics capped at the media limit, and an updated amount of questions capped at the assessment limit.

In some aspects, course generator 102 receives, via the GUI 106, a third user selection to update the custom organizational scheme based on a preferred difficulty level for comprehending the topic. Course generator 102 determines a respective difficulty level of each reference material in the database. Course generator 102 further retrieves updated content from at least one reference material with a difficulty level that matches the preferred difficulty level. For example, if the preferred difficulty is the high school level and the current difficulty level in the default organizational scheme is university level, course generator 102 may select a high school textbook to generate the content. Course generator 102 may then automatically update the content displayed in the GUI 106 to the updated content in accordance with the custom organizational scheme.

In some aspects, course generator 102 receives, via the GUI 106, a fourth user selection to update the custom organizational scheme based on a preferred subset of sub-topics to include from a plurality of topics. For example, as shown in FIG. 3, course generator 102 may allow the user to select the sub-topics to include in the syllabus. In response, course generator 102 automatically updates the content displayed in the GUI 106 in accordance with the custom organizational scheme by filtering out the existing content from the content, wherein the existing content comprises information unrelated to the preferred subset of sub-topics. By filtering out information, the duration to complete the course may decrease. Accordingly, course generator 102 adds additional content to the content to match the preferred duration, wherein the additional content comprises information related to the preferred subset of sub-topics.

In some aspects, course generator 102 receives, via the GUI 106, a reference material or a link to the reference material to use for generating the content, and adds the reference material to the database, wherein the one or more reference materials comprise the reference material received via the GUI.

In some aspects, course generator 102 receives, via the GUI 106, a new topic that is not included in the plurality of topics and at least one reference material that describes the new topic. Course generator 102 parses the at least one reference material to identify a plurality of new sub-topics related to the new topic. Course generator 102 extractes, from the at least one reference material, information about each of the plurality of new sub-topics.

Course generator 102 of the present disclosure is an improvement in computer technology—particularly with regard to GUIs. A traditional user interface may display the content found in a reference material (e.g., generate a web page), but fails to limit the amount of information shown based on specific user preferences such as duration, difficulty, sub-topic preference, etc. Course generator 102 is configured to generate an improved GUI that presents information that is relevant to the user and automatically updates as the user's preferences are updated.11

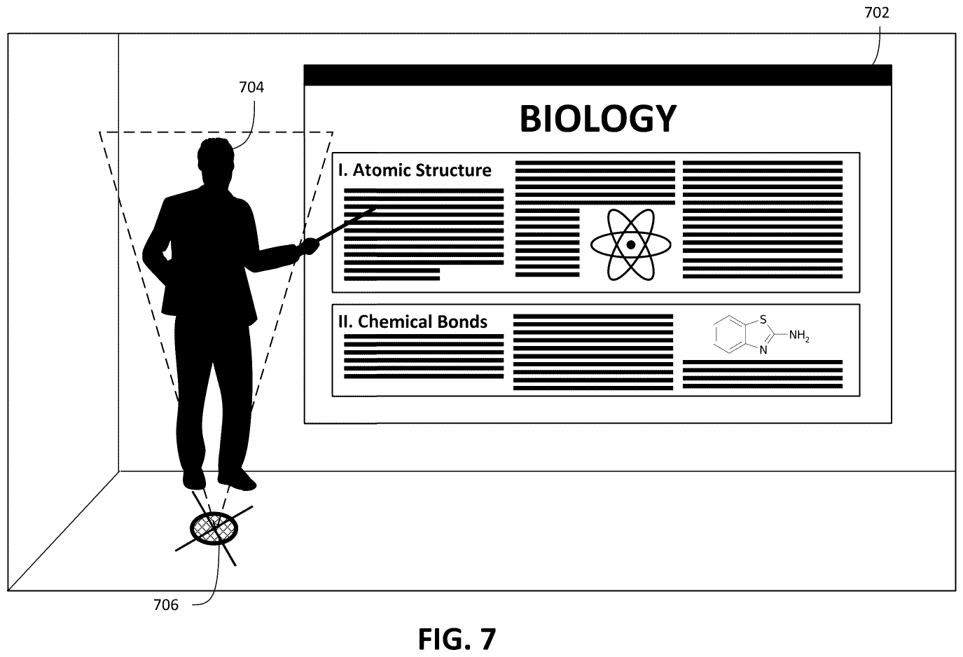

FIG. 7 is a diagram illustrating an exemplary teaching avatar. In FIG. 7, computing device 101b, which outputs GUI 124 depicting course 122, is device 702. Suppose that device 702 is a smartboard installed in a classroom. Avatar 704 (corresponds to avatar 125) is a hologram generated by a hologram generator device 706.

Hologram generator device 706 may use a combination of optics, lasers, and/or physical screens to create the illusion of three-dimensional images floating in space. For example, device 706 may be a holographic projector that uses advanced optics and lasers to create true holographic images such as that of avatar 704.

In some aspects, avatar 704 may not be physically generated by a hologram generator device 706. Instead, avatar 704 may be seen by a student using an augmented reality, virtual reality, or mixed reality headset. In this case, the visual of avatar 704 is overlaid on an image captured by the headset of the surrounding environment. For example, using the headset, a student may look in the direction of device 702. Avatar generator 117 may set the position of the avatar to be a threshold distance (e.g., 0.5 meters) away from device 702. As a result, the student sees the contents of device 702 and avatar 704 standing beside the device 702.

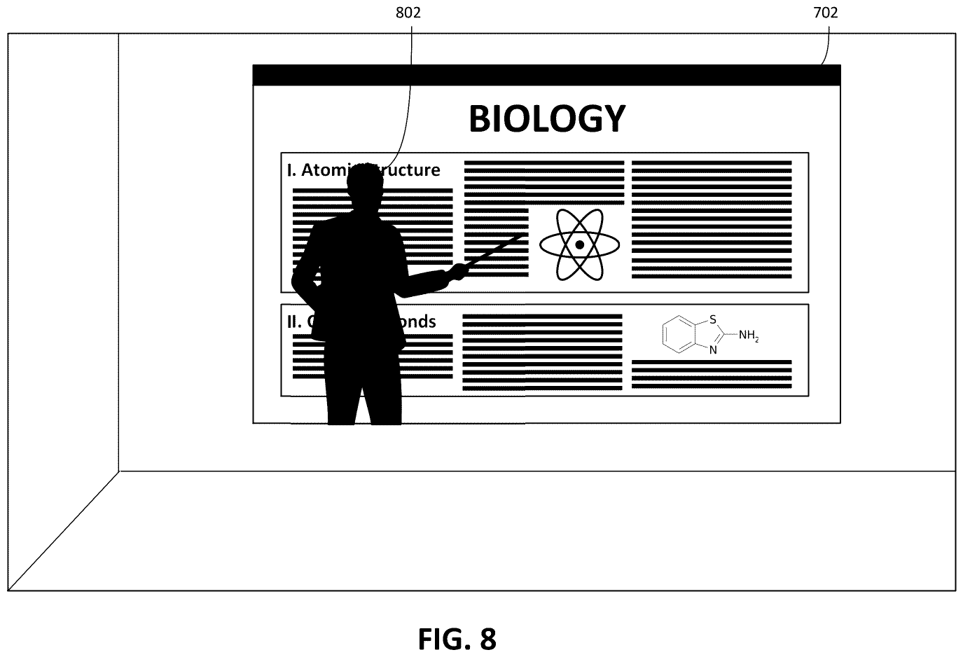

FIG. 8 is a diagram illustrating another exemplary teaching avatar. In order to realize the avatar creation shown in FIG. 7, at least one other device is needed alongside computing device 101b. For example, the other device may be a headset or a hologram projector. In the event that neither of those devices are available, the avatar may be generated for display on the sole device available. In FIG. 8, avatar 802 (corresponds to avatar 125) is generated directly on device 702. For example, avatar 802 may be overlaid on the course content of course 122.

Consider the following operation of the avatar 802. Course 122 presents an educational topic to a user and the avatar administers a lecture associated with the topic. For example, the topic may be biology, and avatar 802 may begin to read the content generated for the sub-topic called atomic structures. In some aspects, the appearance and the voice of avatar 802 may be generated based on class attributes in input 104. For example, if the course is being taught in a south Asian country, avatar 802 may take the appearance of a south Asian teacher. Accordingly, the body structure, facial features, and clothes may match those associated with a south Asian. Likewise, the language in which the course is taught may be a south Asian language such as Hindi or Urdu. The mannerisms (e.g., gestures, analogies, word choice, phrases, etc.) of the avatar 802 may also match those of a south Asian.

In some aspects, avatar 802 outputs the course material through an oral lecture. For example, avatar 802 may read a script associated with the sub-topic that summarizes the content generated for the sub-topic in the custom course. In another aspect, avatar 802 may have a “writing” animation in which the content of the course is “written” on the smartboard as the avatar 802 gives the lecture. For example, avatar 802 may write a line from the summarized content of the sub-topic as a bullet point, say the line aloud, and then continue to the next line. In order to accommodate for the time it takes the avatar 802 to write and say the line, the duration of the course may be adjusted. For example, the content may be reduced to ensure that within a certain time limit (e.g., 1 hour), the important concepts of the sub-topic can be taught to the students.

In some aspects, avatar 802 is configured to continuously monitor for student statements and gestures. For example, a camera may be panned at the classroom as a peripheral device connected to both devices 706 and 702. In response to detecting a gesture from a student indicative of a desire to make a statement, avatar 802 may execute a selection gesture indicative of acknowledging the student. For example, the student may raise his/her hand, which triggers avatar 802 to make a selection gesture. Avatar 802 may then record an audio clip of the student's statement. For example, the student may ask a question or request that a concept be repeated. Avatar 802 may parse this statement and generate a response. For example, avatar 802 may output an answer the question or grant the request. It should be noted that students may also provide statements by typing them in a chat connected to avatar 802 (e.g., avatar 802 responds as a chatbot) or writing them on device 702 (e.g., drawing on the smartboard).

In some aspects, avatar 802 may search for responses to the statements using a supplemental branch of the custom course. Avatar 802 may assess the necessary depth/complexity/duration of the answer based on class attributes and course difficulty/duration. In some aspects, the system generates avatar code and additional content to respond to student statements.

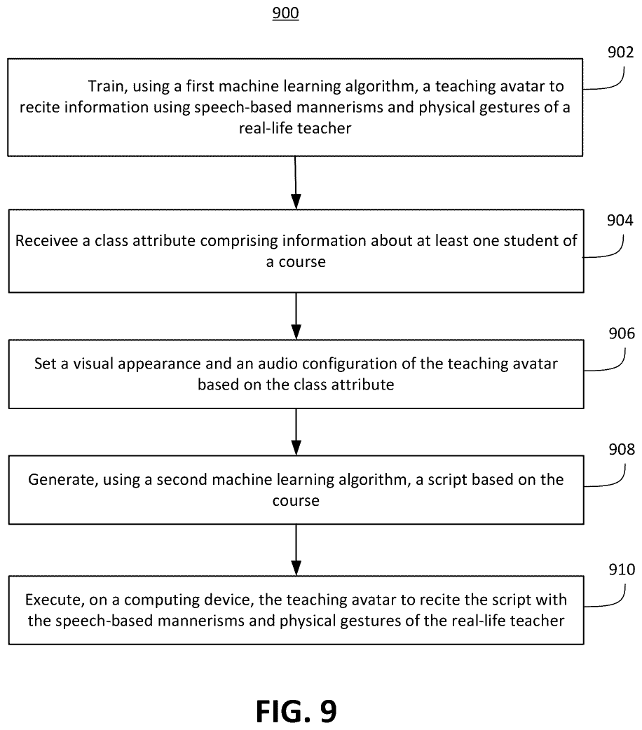

FIG. 9 is a block diagram illustrating method 900 for generating a teaching avatar using machine learning. At 902, avatar generator 117 trains, using a first machine learning algorithm, a teaching avatar to recite information using speech-based mannerisms and physical gestures of a real-life teacher. Here, the training is performed with a training dataset comprising videos and transcripts of real-life teachers administering courses. For example, the training dataset may include, for each video, a corresponding transcript that is a text document listing what is said in the video and the timestamps. In one hour long video, for example, a teacher may say at the 45th minute, “this summarizes the general details about DNA, any questions?.” The first machine learning algorithm may include a pose estimator that analyzes the physical gestures of the teacher as he/she makes that statement. For example, the teacher may turn around and point to the class. In general, the physical gestures include body part movement, facial feature movement, and physical interactions.

The first machine learning algorithm may further include a speech recognition algorithm that classifies how the statement was delivered in terms of speech-based mannerisms. For example, the speech-based mannerisms may include one or more of frequency of pauses, length of the pauses, talking speed, tone, and diction. For example, there may be a pause between the words “DNA” and “any” in the statement. The entire statement may be said in 3 seconds. The tone of the teacher may be classified as confident. The diction encompasses word/phrase choice. For example, rather than saying “are there any questions,” the teacher casually says “any questions.”

With the videos and transcripts labelled with these features, the teaching avatar is trained to emulate the real-life teacher. This ultimately helps the user navigate through the educational content. Because the teaching avatar is part of the user interface, rather than relying on static text and images to consume information, users can take advantage of the teaching avatar's guidance when navigating through a course.

It should be noted that one of the physical gestures that the teaching avatar may copy is the motion of writing on a hard surface. For example, it is common for teachers/professors to write notes on a board for students to copy. The teaching avatar may be thus be trained to mimic this interaction.

At 904, avatar generator 117 receives a class attribute comprising information about at least one student of a course. At 906, avatar generator 117 sets a visual appearance and an audio configuration of the teaching avatar based on the class attribute. In some aspects, the course is a custom course generated using a user interface. This custom course may be generated specifically using course generator 102. While step 902 focuses on how the teaching avatar will move (e.g., poses, gestures, etc.) and how the teaching avatar will speak, steps 904 and 906 focus on the visual and audio configurations of the teaching avatar. For example, avatar generator 117 may have a plurality of avatar models to select from. Each avatar model may have a certain appearance and voice.

For example, the teaching avatar appears as a human in a first avatar model. The class attribute may indicate an ethnic background of the at least one student. For example, the class attribute may indicate a specific ethnicity, country of origin, religion, etc. Avatar generator 117 may thus set the visual appearance of the teaching avatar by adjusting an ethnicity of the human to match the ethnic background of the at least one student. If the course is being administered in South Asia, for example, avatar generator 117 may make the human in the first avatar model South Asian.

Adjusting the ethnicity of the human comprises adjusting at least one physical characteristic of the teaching avatar based on known physical characteristics of humans belonging to the ethnic background. These known physical characteristics may be stored in a database accessible to course generator 102. The at least one physical characteristic may include facial features, hair texture, skin color, and body type.

In some aspects, the class attribute comprises a gender preference. For example, the course may be administered in an all-boys school. Avatar generator 117 may thus set the visual appearance of the teaching avatar by adjusting a gender of the human to accommodate the gender preference (e.g., make the avatar a man).

In some aspects, the class attribute comprises a language preference (e.g., a preferred language, dialect, etc.). Avatar generator 117 may set the audio configuration of the teaching avatar by adjusting a language spoken by the teaching avatar to accommodate the language preference. For example, if the course is being taught in the United Kingdom, the preferred language will be English with a British accent.

At 908, avatar generator 117 generates, using a second machine learning algorithm, a script based on the course. As mentioned previously, course generator 102 may be used to generate the course that is administered by the teaching avatar. However, rather than reading the generated text word-for-word, the second machine learning algorithm may be used to further summarize each sub-topic in the generated course into a script. The second machine learning algorithm may rely on a training dataset that includes text and an associated script for the text to determine how to prepare arbitrary scripts for input texts. Thus, at 908, the text from the generated course is input into the second machine learning algorithm, which outputs a script for the teaching avatar to read. This script may include questions that that teaching avatar is to ask students.

In some aspects, the teaching avatar may serve as an artificial intelligence chatbot that receives a user query (e.g., an audio input, a text input, a gesture, etc.) and generates a response to the user query. For example, a student may answer a question recited by the teaching avatar from the script. The user query comprises the answer and the response indicates whether the answer is correct. Avatar generator 117 may further insert the response to the script for the teaching avatar to recite. In another example, if the student has a question about the material, the chatbot feature enables the teaching avatar to provide clarifying material.

At 910, avatar generator 117 executes, on a computing device, the teaching avatar to recite the script with the speech-based mannerisms and physical gestures of the real-life teacher. In some aspects, the computing device is a hologram projector device.

In some aspects, the teaching avatar is trained to making a writing gesture that corresponds to writing the script. For example, as shown in FIG. 8, the teaching avatar may make a writing gesture and write notes that appear on device 702.

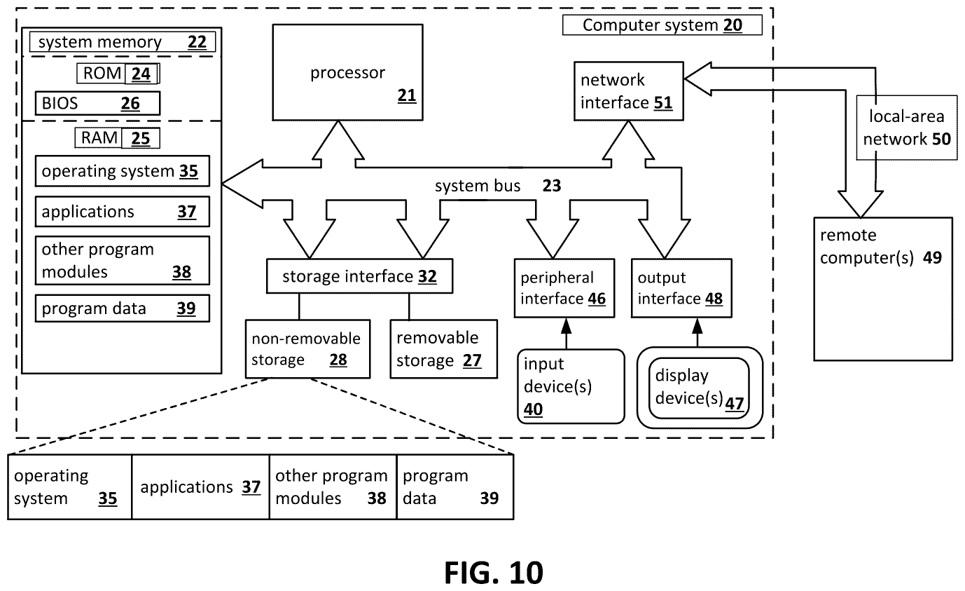

FIG. 10 is a block diagram illustrating a computer system 20 on which aspects of systems and methods for generating custom courses on a user interface using machine learning may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-6 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

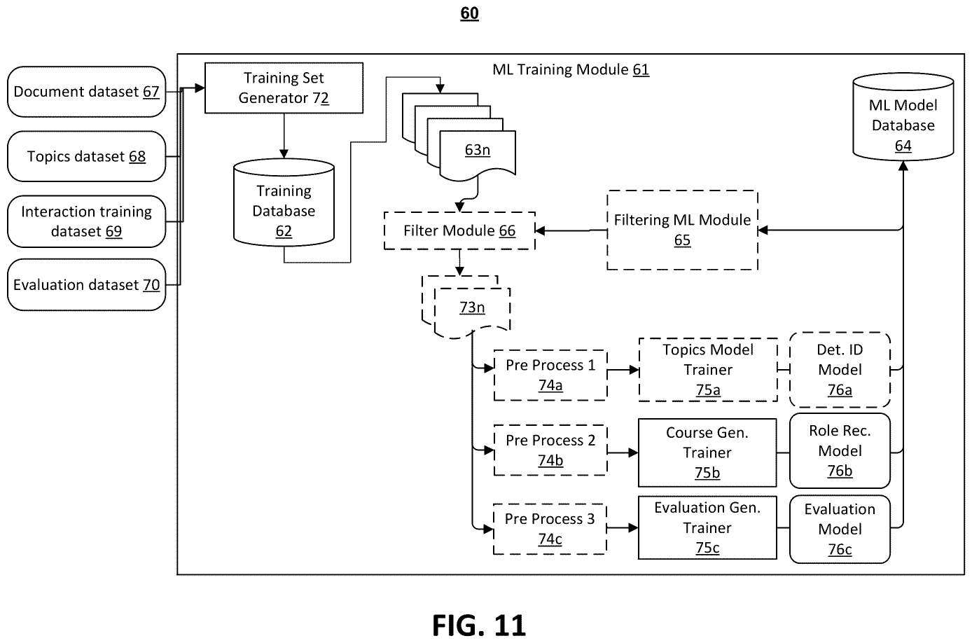

FIG. 11 is a block diagram illustrating a system 60 for training course generator 102 to generate custom courses according to aspects of the present disclosure. As shown in example 60, a ML training module 61 is configured to build and train specialized machine learning models with inference to perform particular tasks. This enables the specialized machine learning models to develop an ability to perform particular objectives on inputs that are not part of a training dataset. By subjecting the specialized machine learning models to large amounts of unlabeled and/or labeled trained image data sets, the specialized machine learning models may perform particular tasks such as course generation.

Supervised learning is effective for tasks such as classification (assigning inputs to predefined categories) and regression (predicting continuous values) since it relies on the availability of labeled data for both training and evaluation phases. In supervised learning, the ML training module 61 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the ML training module 61 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the ML training module 61 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the ML training module 61 includes at least a training database 62 configured to store the raw training data 63n and corresponding labels, a ML model database 64 to store the trained models (e.g., model 76a, 76b, 76c, etc.). In some aspects, the ML training module 61 may include a filtering machine learning model 65 and a filter module 66 configured to filter data from the training database 62 for training by removing poorly generated training data.

Training data from the document dataset 67, topics dataset 68, interaction training dataset 69, and evaluation dataset 70 is received into the ML training module 61 via the training set generator 72. In some aspects, document dataset 67 includes documents and summarized versions of said documents, topics dataset 68 includes text and identified topics in the text, interaction training dataset 69 includes clickstream user data on the UI, and evaluation dataset 70 including question and answer student performance.

An optional filter module 66 is configured to filter out bad training images and/or data in order to clean up the training data in the training dataset 63n. In some examples, the filter module 66 may be a neural network. In some examples, the filter module 66 is a mathematical model. In some examples, the cleaned training dataset 73n then undergoes optional preprocessing steps depending on which neural network or model is being trained.

The optional preprocess 1 74a, preprocess 2 74b, and preprocess 3 74c are automated processes that modify the raw data received from 63n (or cleaned training dataset 73n) and prepare the raw data as input to the respective model trainers (e.g., a people/object detection model trainer 75a, a role recognition model trainer 75b, and an evaluation model trainer). These may be described in the machine learning training module 61 as snippets of code that prepares the datasets. In some examples, the preprocessing module (e.g., preprocess 1 74a, preprocess 2 74b, and preprocess 3 74c) for a particular trainer may be an automated script or code that will be setup the first time any model is trained.

The topics model trainer 75a, course generation trainer 75a, and evaluation generation trainer 75c are the scripts or code that train the model. The topics model trainer 75a, course generation trainer 75a, and evaluation generation trainer 75c may be a script or code that holds the instructions on how a model should be trained (e.g., optimization method, model architecture, dataset division, etc.) and also runs the training. The topics model trainer 75a, course generation trainer 75a, and evaluation generation trainer 75c each take as input the raw or filtered processed training data and train topics model 76a, course generation model 76b, and evaluation generation model 76c to achieve their specific objectives, respectively.

In summary, the raw dataset 63n or cleaned dataset 73n may optionally go through different preprocessing steps 74a, 74b, and 74c and then a corresponding topics model trainer 75a, course generation trainer 75a, and evaluation generation trainer 75c to generate a trained model 76a, a trained course generation model 76b, and a trained evaluation generation model 76c. In some examples, each of these models may be a neural network.

As a non-limiting example, the machine learning may be a neural network. The neural network models are designed using a set of hyperparameters that define high-level aspects of their architecture and training process. These hyperparameters include, but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 63n used for training may include noise and bad training images from the training database 62. Accordingly, to create a clean and filtered training dataset, the filter module 66 is configured to filter out unwanted data points from the raw training dataset 63n by developing smaller, less accurate systems based on patterns and metadata information.

During the training process, topics model trainer 75a, course generation trainer 75a, and evaluation generation trainer 75c (e.g., neural networks) are presented with input data and labels of actual values, and the optimization objective, which aims to minimize the difference between the actual value and the predicted value, is calculated. The optimization algorithm updates the parameters of topics model trainer 75a, course generation trainer 75a, and evaluation generation trainer 75c to reduce the value of the objective. This process is repeated for several iterations until the parameters do not change anymore. This process is repeated for various combinations of hyperparameters, and the model with the smallest label prediction error is selected as the final model.

When a new model (e.g., a trained topics model 76a, a trained course generation model 76b, and a trained evaluation generation model 76c) is created, and a new process for filtering and automated labeling is established, it is added to the ML model database 64 in the ML training module 61. This enables the new model to be part of the closed-loop model update process. Optionally, at regular intervals, data which is continuously collected can be filtered, labeled, and used to update old models by an optional filtering machine learning module 65. In some examples, the filtering machine learning module 65 is a neural network. In some examples, the filtering machine learning module 65 is a mathematical model. This approach may capture changes in the data over time.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for generating a teaching avatar using machine learning, the method comprising:
training, using a first machine learning algorithm, a teaching avatar to recite information using speech-based mannerisms and physical gestures of a real-life teacher, wherein the training is performed with a training dataset comprising videos and transcripts of real-life teachers administering courses;
receiving a class attribute comprising information about at least one student of a course;
setting a visual appearance and an audio configuration of the teaching avatar based on the class attribute;
generating, using a second machine learning algorithm, a script based on the course; and
executing, on a computing device, the teaching avatar to recite the script with the speech-based mannerisms and physical gestures of the real-life teacher.

2. The method of claim 1, wherein the speech-based mannerisms comprises one or more of frequency of pauses, length of the pauses, talking speed, tone, and diction.

3. The method of claim 1, wherein the physical gestures comprise body part movement, facial feature movement, and physical interactions.

4. The method of claim 3, wherein the physical interactions comprises writing information on a surface.

5. The method of claim 4, wherein the teaching avatar is trained to making a writing gesture that corresponds to writing the script.

6. The method of claim 1, wherein the script comprises questions to ask the at least one student.

7. The method of claim 1, further comprising:
receiving a user query;
generating a response to the user query; and
inserting the response to the script for the teaching avatar to recite.

8. The method of claim 1, wherein the computing device is a hologram projector device.

9. The method of claim 1, wherein the teaching avatar appears as a human, wherein the class attribute comprises an ethnic background of the at least one student, and wherein setting the visual appearance of the teaching avatar comprises adjusting an ethnicity of the human to match the ethnic background of the at least one student.

10. The method of claim 9, wherein adjusting the ethnicity of the human comprises adjusting at least one physical characteristic of the teaching avatar based on known physical characteristics of humans belonging to the ethnic background, wherein the at least one physical characteristic comprises facial features, hair texture, skin color, and body type.

11. The method of claim 1, wherein the teaching avatar appears as a human, wherein the class attribute comprises a gender preference, and wherein setting the visual appearance of the teaching avatar comprises adjusting a gender of the human to accommodate the gender preference.

12. The method of claim 1, wherein the class attribute comprises a language preference, and wherein setting the audio configuration of the teaching avatar comprises adjusting a language spoken by the teaching avatar to accommodate the language preference.

13. The method of claim 1, wherein the course is a custom course generated using a user interface.

14. A system for generating a teaching avatar using machine learning, comprising:
at least one memory;
at least one hardware processor coupled with the at least one memory and configured, individually or in combination, to:
train, using a first machine learning algorithm, a teaching avatar to recite information using speech-based mannerisms and physical gestures of a real-life teacher, wherein the training is performed with a training dataset comprising videos and transcripts of real-life teachers administering courses;
receive a class attribute comprising information about at least one student of a course;
set a visual appearance and an audio configuration of the teaching avatar based on the class attribute;
generate, using a second machine learning algorithm, a script based on the course; and
execute, on a computing device, the teaching avatar to recite the script with the speech-based mannerisms and physical gestures of the real-life teacher.

15. The system of claim 14, wherein the speech-based mannerisms comprises one or more of frequency of pauses, length of the pauses, talking speed, tone, and diction.

16. The system of claim 14, wherein the physical gestures comprise body part movement, facial feature movement, and physical interactions.

17. The system of claim 16, wherein the physical interactions comprises writing information on a surface.

18. The system of claim 17, wherein the teaching avatar is trained to making a writing gesture that corresponds to writing the script.

19. The system of claim 14, wherein the script comprises questions to ask the at least one student.

20. A non-transitory computer readable medium storing thereon computer executable instructions for generating a teaching avatar using machine learning, including instructions for:
training, using a first machine learning algorithm, a teaching avatar to recite information using speech-based mannerisms and physical gestures of a real-life teacher, wherein the training is performed with a training dataset comprising videos and transcripts of real-life teachers administering courses;
receiving a class attribute comprising information about at least one student of a course;
setting a visual appearance and an audio configuration of the teaching avatar based on the class attribute;
generating, using a second machine learning algorithm, a script based on the course; and
executing, on a computing device, the teaching avatar to recite the script with the speech-based mannerisms and physical gestures of the real-life teacher.
